(19) United States
(12) Patent Application Publication
(10) Pub. No.: US 2018/0209458 A1
(43) Pub. Date: Jul. 26, 2018

(54) Multiple Part Component and Method of Assembly

(71) Applicant: Rolls Royce plc, London (GB)

(72) Inventor: Alistair J. E. SMITH, Nottingham (GB)

(73) Assignee: Rolls Royce plc

(21) Appl. No.: 15/878,795

(22) Filed: Jan. 24, 2018

(30) Foreign Application Priority Data
Jan. 26, 2017 (GB) 1701309.5

(51) Int. Cl. F16B 5/08; B23K 15/00

(52) U.S. Cl. CPC F16B 5/08; B23K 15/0053

(57) ABSTRACT

This application describes a manufactured component and method for forming the component. The component comprises: a plurality of parts (212, 214) joined together by a straight line joint (216) and a multi-faceted joint (218). The plurality of parts define a cavity (236) having an internal surface (226) and an external (222) surface. The straight line joint extends through a wall of the component along a straight line between the external surface the internal surface; and, the multi-faceted joint includes an external joint line extending from an external surface to meet an internal joint line which extends from an internal surface, the external and internal joint lines being at an angle to one another. The internal joint line and the straight line joint are aligned with one another such that a straight line extending from the straight line joint will coincide with the internal joint.

### CROSS REFERENCE TO RELATED APPLICATION

This disclosure claims the benefit of GB Patent Application No. GB1701309.5 filed on 26 Jan. 2017, which is hereby incorporated herein in its entirety.

### FIELD OF DISCLOSURE

The present disclosure relates to a multiple part component and method of assembly. The multiple parts are assembled into a pre-form prior to being welded. The method of welding may be an electron beam welding technique.

### BACKGROUND OF DISCLOSURE

FIGS. 1a and 1b show a multipart component 10 which is constructed from a first part 12 and a second part 14. The first 12 and second 14 parts are individually manufactured and subsequently joined together at two joints 16, 18. The joints 16, 18 may be welded together using any suitable technique.

One suitable welding technique is electron beam welding which uses a beam of high-velocity electrons to fuse the respective parts together. The electrons collide with the work piece creating localised heat sufficient to metal the target area. The electrons penetrate a work piece making it possible to weld cross sections. The amount of heat generated and penetration of the beam depends on several variables include the beam strength, size and speed at which it traverses the work piece. Different thicknesses and types of metal may be joined using electron beam welding.

Using electron beam welding minimises the heat generated in the surrounding areas of the component and thus helps to reduce thermally related distortion during the assembly. Each joint includes a joint defined by a two abutting faces. The joint faces are straight in the weld direction so that the beam can penetrate the full width of the joint. The faces may be planar but this need not be the case and the beam may be moved in multiple axes to follow the joint line across or around a component.

The joints are welded with individual energy beams. The beams are required to penetrate through the depth of each joint to provide a satisfactory full thickness weld. In order to achieve this, the beam needs to pass through the work piece which can result in it colliding with the opposing internal surface. To prevent damage occurring on the opposing internal surface by the incident emergent beam, protective tooling may be placed in the path of the beam line to absorb the excess beam energy after it has penetrated the joint. However, this can be difficult in a hollow component in which access may be limited. In such a case, the component may need to be designed with additional sacrificial surfaces or mass.

Alternatively, the protective tooling may be collapsible such that it can be inserted prior to assembly and collapsed or disassembled after the welding operation is complete.

A further complication with both of these safeguarding methods is that the protective measure must be capable of undergoing multiple welds in a given location where the initial weld is deemed to be substandard in post weld inspection and a re-weld is required.

The present invention seeks to provide an improved multipart component and method for manufacturing such a part.

### SUMMARY OF THE DISCLOSURE

The present disclosure provides a manufactured component and method of manufacture according to the appended claims.

The present disclosure provides a manufactured component, comprising: a plurality of parts joined together by a straight line joint and a multi-faceted joint, the plurality of parts defining a cavity having an internal surface and an external surface; wherein the straight line joint extends through a wall of the component along a straight line between the external surface the internal surface; and, the multi-faceted joint includes an external joint line extending from an external surface to meet an internal joint line which extends from an internal surface, the external and internal joint lines being at an angle to one another, wherein the internal joint line and the straight line joint are aligned with one another such that a straight line extending from the straight line joint will coincide with the internal joint.

Providing a multi-faceted joint aligned with a straight line joint allows the two joins to be simultaneously welded. Further, the multi-faceted joint can provide a location feature.

The external joint line and internal joint line provide first and second facets of the multi-faceted joint. The internal joint and external joint may be connected by a further joint line. The further, or third, joint line may provide a further facet of the multi-faceted joint.

The component may include a plurality of walls interconnected at nodes, wherein the multi-faceted joint is located at a node. The multi-faceted joint may be located along the length of a wall or at a node. The straight line joint may be located along the length of a wall or at a node.

The angle between the through thickness line of the external joint and the through thickness line of the internal joint may lie between 60 and 135 degrees to one another.

The line of the external joint and line of the internal joint may lie between 80 and 110 degrees. The angle may be approximately 90 degrees.

One part of the two parts may include a node and two walls extending therefrom to respective free ends. At least a portion the respective free ends may include end faces which lie in a common plane to one another to provide a straight line joint surface and an internal joint surface.

The internal joint line of the multi-faceted joint may be shorter than the external joint line. The internal joint line may be half the length of the external joint line.

The cavity may be substantially triangular. The component may have a plurality of sides. The component may have any number of sides. The component may include curved or straight sides. The cavity may be round or polygonal. The component may be curved. The component may be tubular. The component may be elongate having a longitudinal axis. The cavity may extend along the longitudinal axis. The component may be annular. The annular component may provide an annular cavity. The component may extend around a central axis. The line between the straight line joint and internal joint may traverse the cavity. The weld beam may traverse the cavity in a plane normal to the longitudinal axis of the cavity. The joint lines may extend through the thickness of the component wall.

The line which extends between the straight line joint may be parallel to a wall of the cavity.

The parallelism may relate to an external wall of the cavity or an alignment feature on the exterior of the component. Providing the straight line joint in this way allows for easier alignment of the component with the e-beam source.

According to the present disclosure there is a method of manufacturing a hollow component having an internal surface and an external surface, the method comprising: providing a plurality of parts for assembly, each part including a joint surface for joining with another of the plurality of parts; assembling the plurality of parts to provide a preform having: a multi-faceted joint which includes an external joint line extending from an external surface to meet an internal joint line which extends from an internal surface, the external and internal joint lines being at an angle to one another; and, a straight line joint which extends from an external surface to an internal surface along a straight line wherein the straight line joint and internal joint lie along a common line; using a first beam to weld the straight line joint and the internal joint line of the multi-faceted joint, and, using a second beam to weld the external joint line of the multi-faceted joint.

The first beam and the second beam may be provided at between 80 and 110 degrees to each other. The first beam and second beam may be provided at right angles to one another.

The plurality of parts may be machined prior to being assembled.

The beams may be are electron beams.

Within the scope of this application it is expressly envisaged that the various aspects, embodiments, examples and alternatives, and in particular the individual features thereof, set out in the preceding paragraphs, in the claims and/or in the following description and drawings, may be taken independently or in any combination. For example features described in connection with one embodiment are applicable to all embodiments, unless such features are incompatible.

### BRIEF DESCRIPTION OF THE DRAWINGS

Embodiments of the invention will now be described with the aid of the following drawings of which:

FIGS. 1a and 1b shows a multipart component which is joined using electron beam welding using known techniques.

FIG. 2 shows a multipart component having a rebate joint and a straightline joint.

FIG. 3 shows the rebate joint in more detail.

FIGS. 4a and 4b show the steps of a welding process.

FIG. 5 shows an alternative multipart component arrangement.

FIGS. 6 to 8 show variances in joint weld parameters.

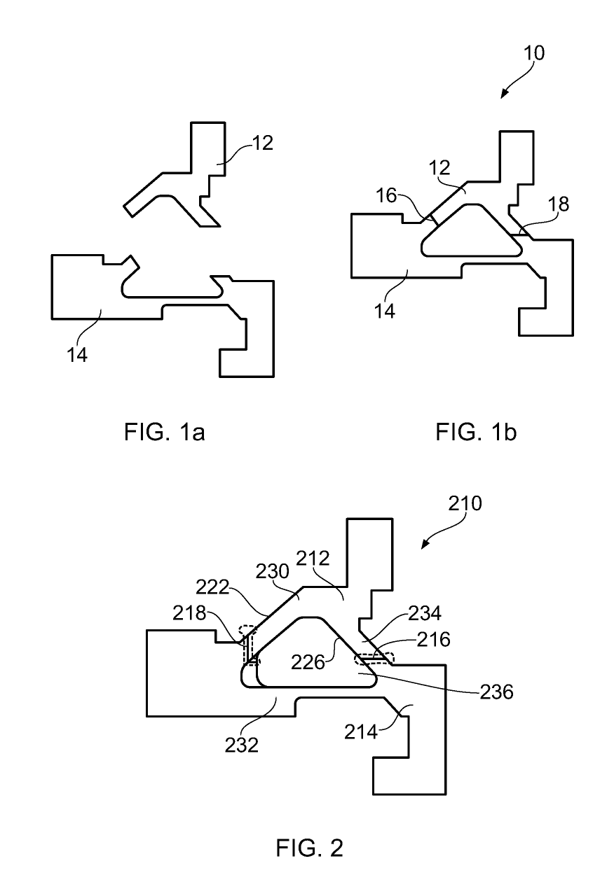

### DETAILED DESCRIPTION OF THE DRAWINGS

FIG. 2 shows a multipart component 210 which includes a plurality of parts 212, 214 which form therebetween a cavity. The parts are fused together at first 216 and second 218 joints. The first joint 216 is a straight line joint which extends between external 222 and internal 226 surfaces of the cavity along a straight line. The second joint 218 is a multi-faceted joint having multiple joint surfaces extending in series between the internal and external surfaces of the component.

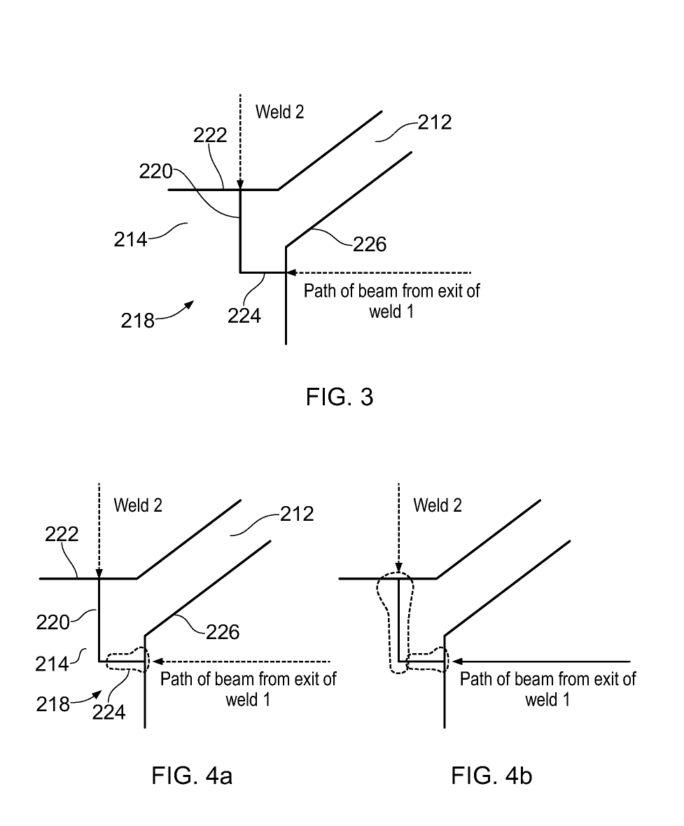

The multi-faceted joint is in the form of a rebate joint 218 which is more clearly shown in FIG. 3 and includes a first part 212 and a second part 214 joined in unison at an interface having multiple corresponding facets which abut one another when in arranged prior to welding. The rebate joint includes an external joint line 220 extending from an external surface 222 to meet an internal joint line 224 which extends from an internal surface 226 of the component. The external 220 and internal joint 224 lines are at an angle to one another such that the joint is not straight and cannot be welded by a single energy beam. Thus, the external joint 220 and the internal joint 224 each extend along an axis or straight line from a surface of the component into its mass.

Returning to FIG. 2, it can be seen that the straight line of the internal joint line 224 is aligned with the straight line of the first joint. Hence, a cross cavity extension to the straight line of the first joint coincides with the internal joint of the rebate joint. This alignment allows the internal joint of the rebate joint to be welded simultaneously with the first joint and using the same energy beam. The external joint of the rebate joint is subsequently, or previously, welded with a second beam. The welds are indicated schematically with the dashed lines which surround the joint interfaces in FIG. 2 and show the through thickness weld line for each joint.

The separation between the internal joint and straight line joint may be any which allow a successful weld. Typically, the range would be somewhere between 10 mm and 300 mm. The internal joint 224 may have a length anywhere between the weld thickness of the external joint, and approximately twice the length of the straight line joint. The internal joint may be terminated with a thickness of greater than 2 mm of the internal joint length to allow the energy beam sufficient depth to dissipate without breaking through. However, the internal joint may break through in some instances. In such a case, the multifaceted joint may be a T shaped joint with the internal line extending between an internal surface and an external surface, and the external line terminating at or beyond the internal joint line.

FIGS. 4a and 4b illustrate the sequential steps of the welding process according to one example. Hence, FIG. 4a shows the first energy beam which has emerged from the first welded straightline joint (not shown) and collides and penetrates the internal joint of the rebate joint. Prior to, simultaneously or subsequently, the external joint is welded with a second beam.

The welds could be done in any sequence but the advantage of doing the straight line and internal joint in a first weld is that it fixes the position of rebate joint and prevents any deleterious movement. Welding with the external joint of the rebate joint first could result in the straight line joint moving resulting in some misalignment.

The energy beam may be an electron beam which is particularly suited to through-welding of multiple joints simultaneously. Laser beams may also be used.

It will be appreciated that the laser or electron beam will be moved along the component welding the joints along the length or circumference of the component.

Returning to FIG. 2, the component 210 includes an arrangement of walls 230, 232, 234, which define a cavity 236 therein. Each wall has an internal surface and an external surface in relation to the cavity. The cavity may be fully enclosed or may be provided within one or more openings or apertures. The component may be a straight or curved, linear or circular. The example in FIG. 2 shows a transverse section of an annular component which extends around a central axis at a uniform radius, thereby providing an annular cavity. The component may provide a full annulus, or a segment thereof, and may be generally curved along its length.

The cavity 236 is defined predominantly by three walls arranged in triangular formation which is substantially isosceles having a base 232 and two sides 230, 234, extending therefrom. In the case of an annular component as shown in FIG. 2, the base wall may lie parallel to the central axis. The walls joint each other at respective nodes which provide a junction between the walls. Each node where the walls connect may include an attachment feature or flange for the component. Such features may provide the structure with increased strength and/or a means of locating the component within or to another component.

The rebate joint 218 may be formed from two or more abutting surfaces which are provided by two or more different parts. The rebate may be in any form which comprises intersecting transverse straight joint lines. The rebate may from a notch in one of the wall lengths or a node. The notch may be in the form of a step or v-shaped. The notch may have orthogonal surfaces or facets arranged at an angle to one another. The surfaces may be at any angle to one another which provides sufficient angular change that the two joint lines may be welded with separate beams.

The angle may be between 60 and 135 degrees but will typically be an angle which aids location of the two components by offering some positive engagement and which also does not obstruct the energy beam welding process. In the example shown the angle is approximately 90 degrees.

One or other of the external or internal joint surfaces fulfills two functions. The first is to provide a location feature for locating and seating the components together. The second is to provide an end stop of material for the weld beam to dissipate into without breaching the confines of the component.

The external joint surface and internal joint surface may be similar or different lengths. For example, one of the internal or external joint surfaces may be significantly shorter than the other. Typically, the shorter joint line will be the internal one to reduce the energy required of the beam which welds the straight line joint. The internal joint may be approximately half the length of the external joint.

The walls of the component which define the cavity may be split between the two components in any ratio, provided the straight line first joint and internal joint of the rebate joint can be concentrically aligned. Thus, as shown in FIG. 2, the first part 212 may include a body or node having two walls 230, 234 extending therefrom at an angle to the body and to each other. The walls extend from a fixed end at the node to a free end. The end faces of the free ends provide the joint surfaces of the joints, including respective portions which lie in common plane. The common plane provides the concentric line along which the beam will pass during welding to fuse the respective parts of the straight line and rebate joints.

The second component includes a single wall extending between two nodes. This wall does not include any joints.

The line or plane along which the straight line joint and internal joint of the rebate extend may lie parallel to one of the walls or another feature of the component which can be readily used as a reference plane for holding the component in an energy beam welding device or fixture. Providing this relation between the joint line and an external feature allows the combined weld line to be aligned to an axis of the machine which can simplify the movement of the energy beam source.

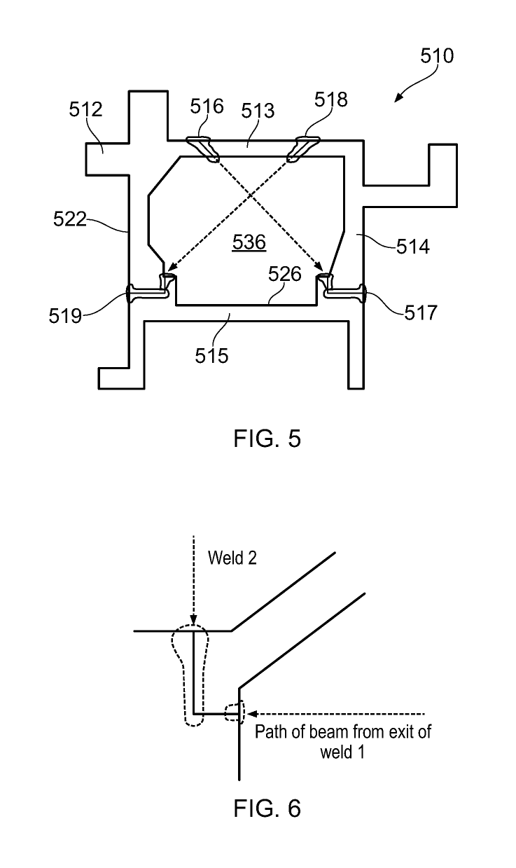

FIG. 5 provides a further example of a multipart component which has corresponding reference numerals as those used in FIG. 2 for the similar features but incremented by 300. Thus there is shown a multipart component 510 which includes four parts 512, 513, 514, 515 which form therebetween a cavity 536. The parts are fused together using two rebate-straight line joint pairs at first 516 and second 517 joints, and three 518 and fourth 519 joints. The first joint 516 and third 518 joints are straight line joints which extend between external 522 and internal 526 surfaces of the cavity along a straight line. The second joint 517 and fourth joints 519 are rebate joints having multiple joint surfaces extending in series between the internal 522 and external 526 surfaces of the component.

As with the previous example, the line of the internal surface joins are concentric with the straight line of the first joint. Hence, a cross cavity extension to straight line of the first joint coincides with the internal joint of the rebate joint. This alignment allows the internal joint of the rebate joint to be welded simultaneously with the first joint and using the same energy beam. The external joint of the rebate joint is subsequently, or previously, welded with a second beam. Here the angle between the internal surface joint line and external surface joint line is around 135 degrees.

FIG. 6 shows an alternative in which weld on the internal joint of the multi-faceted joint does not extend for the full length of the surfaces of the internal joint. Thus, there is a partial weld. This may be carried out where mechanical constraints allow.

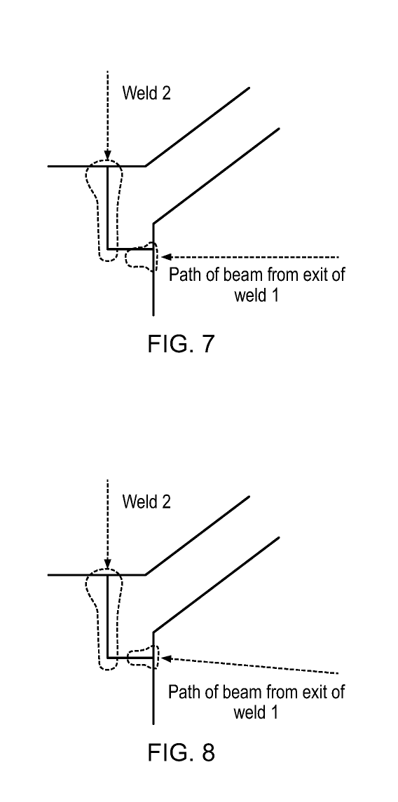

FIGS. 7 and 8 show instances where there is a degree of misalignment between the internal joint and the straight line joint. The partial misalignment is not severe enough that the weld line is moved away from the internal joint of the rebate joint, but may show that there is not a true alignment between the straightline which extends from the first joint across the internal cavity of the assembly work piece. The partial misalignment may be either or both of angular, such that there is an angle between the straight line axis and direction of the internal joint, or an offset in which the two joint lines are laterally offset from one another. The extent of the partial misalignment should be no greater than the radius of the melt pool which result from the welding process.

Thus, as can be seen in FIG. 7, the axis which extends from the opposing straight line joint coincides with the wall of the component in a position which is laterally offset from the parting line between the two parts. The offset is less than the radius of the weld pool or resultant weld bead.

In FIG. 8 there is an angular offset between the beam path and the line of the internal joint. The offset is such that the beam still strikes the line and the weld pool to coalesce the two parts. Thus, the first end of the internal joint is within the weld pool radius.

Typically, lateral offset will be less than 0.5 mm and angular misalignment between the line of the internal joint and the beam line will be less than 45 degrees.

The internal and external surfaces of the parts of the component may be machined prior to assembly into a pre-weld preform.

It will be appreciated that the various joints are described in relation to lines in the transverse section and their associated two dimensional surfaces. It will be appreciated that the surfaces or facets which provide the joint surfaces may lie in planes in which case the straight line joint and internal surface joint of the rebate joint may lie in a common plane. However, where the joint extends along a curved path, the surfaces will not be planar but there will continue to be a straight line between straight line joint and a first end of the internal surface joint of the rebate joint such that the two joins can be fused simultaneously and with a common beam.

The above described example contemplates the invention being used on a simple annular structure. However, the multipart component may include many different parts which may include many different walls and nodes between the walls and multiple joins.

It will be understood that the invention is not limited to the described examples and embodiments and various modifications and improvements can be made without departing from the concepts described herein and the scope of the claims. Except where mutually exclusive, any of the features may be employed separately or in combination with any other features in the disclosure extends to and includes all combinations and sub-combinations of one or more described features.

What is claimed is:

1. A manufactured component, comprising:
a plurality of parts joined together by a straight line joint and a multi-faceted joint, the plurality of parts defining a cavity having an internal surface and an external surface;
wherein the straight line joint extends through a wall of the component along a straight line between the external surface and the internal surface; and,
the multi-faceted joint includes an external joint line extending from the external surface to meet an internal joint line which extends from the internal surface, the external and internal joint lines being at an angle to one another,
wherein the internal joint line and the straight line joint are aligned with one another such that a straight line extending from the straight line joint will coincide with the internal joint line.

2. A manufactured component as claimed in claim 1, wherein the component includes a plurality of walls interconnected at nodes, wherein the multi-faceted joint is located at a node.

3. A component as claimed in claim 1, wherein the angle between a through-thickness line of the external joint line and a through-thickness line of the internal joint line lie between 60 and 135 degrees to one another.

4. A component as claimed in claim 1, wherein one part of the plurality of parts includes a node and two walls extending therefrom to respective free ends, wherein at least a portion the respective free ends include end faces which lie in a common plane to one another to provide a straight line joint surface and an internal joint surface.

5. A component as claimed in claim 1 wherein the internal joint line of the multi-faceted joint is shorter than the external joint line.

6. A component as claimed in claim 1, wherein the cavity is substantially triangular in a cross-section.

7. A component as claimed in claim 1, wherein the straight line which extends between the straight line joint and the internal joint line is parallel to a wall of the cavity.

8. A method of manufacturing a hollow component having an internal surface and an external surface, the method comprising:
providing a plurality of parts for assembly, each part including a joint surface for joining with another of the plurality of parts;
assembling the plurality of parts to provide a preform having:
a multi-faceted joint which includes an external joint line extending from an external surface to meet an internal joint line which extends from an internal surface, the external and internal joint lines being at an angle to one another; and,
a straight line joint which extends from an external surface to an internal surface along a straight line wherein the straight line joint and internal joint lie along a common line;
using a first beam to weld the straight line joint and the internal joint line of the multi-faceted joint, and,
using a second beam to weld the external joint line of the multi-faceted joint.

9. A method as claimed in claim 8, wherein the beams are electron beams.

10. A method as claimed in claim 8, wherein the first beam and second beam are at an angle of between 60 and 135 degrees.

11. A method as claimed in claim 10, wherein the first beam and second beam are provided at right angles to one another.

12. A method as claimed in claim 8, wherein the plurality of parts are machined prior to being assembled.
